(19) United States
(12) Patent Application Publication
(10) Pub. No.: US 2015/0355611 A1
(43) Pub. Date: Dec. 10, 2015

(54) APPARATUS AND METHOD FOR COMBINING VISUALIZATION AND INTERACTION IN INDUSTRIAL OPERATOR CONSOLES

(71) Applicant: Honeywell International Inc., Morristown, NJ (US)

(72) Inventors: GRAEME LAYCOCK, Hunters Hill (AU); ROHAN MCADAM, Yetholme (AU)

(21) Appl. No.: 14/487,276

(22) Filed: Sep. 16, 2014

Related U.S. Application Data
(60) Provisional application No. 62/008,931, filed on Jun. 6, 2014.

(51) Int. Cl. G05B 15/02; G06F 3/0484; G06F 3/0488; G06F 3/0481

(52) U.S. Cl. CPC G05B 15/02; G06F 3/0481; G06F 3/04847; G06F 3/0488

(57) ABSTRACT

A method includes presenting process-related information associated with an industrial process control and automation system to an operator using at least one display device and a touchscreen of an operator console. The method also includes receiving user input via the touchscreen and, based on the user input, (i) controlling the process-related information presented on the at least one display device and the touchscreen and (ii) adjusting operation of the industrial process control and automation system. For example, based on the user input, content can be moved from the display device(s) to the touchscreen or from the touchscreen to the display device(s). As another example, the operation of the industrial process control and automation system can be adjusted by receiving a new value of a process variable based on a first user input and receiving an acceptance of the new value of the process variable based on a second user input.

### CROSS-REFERENCE TO RELATED APPLICATION AND PRIORITY CLAIM

This application claims priority under 35 U.S.C. §119(e) to U.S. Provisional Patent Application No. 62/008,931 filed on Jun. 6, 2014. The above-identified provisional patent application is hereby incorporated by reference in its entirety.

### TECHNICAL FIELD

This disclosure relates generally to industrial process control and automation systems. More specifically, this disclosure relates to an apparatus and method for combining visualization and interaction in industrial operator consoles.

### BACKGROUND

Industrial process control and automation systems are often used to automate large and complex industrial processes. These types of control and automation systems routinely include sensors, actuators, and controllers. The controllers typically receive measurements from the sensors and generate control signals for the actuators.

These types of control and automation systems also typically include numerous operator consoles. Operator consoles are often used to receive inputs from operators, such as setpoints for process variables in an industrial process being controlled. Operator consoles are also often used to provide outputs to operators, such as to display warnings, alarms, or other information associated with the industrial process being controlled. Large collections of operator consoles are often used in control rooms where a number of operators assemble and work.

### SUMMARY

This disclosure provides an apparatus and method for combining visualization and interaction in industrial operator consoles.

In a first embodiment, a method includes presenting process-related information associated with an industrial process control and automation system to an operator using at least one display device and a touchscreen of an operator console. The method also includes receiving user input via the touchscreen. The method further includes, based on the user input, (i) controlling the process-related information presented on the at least one display device and the touchscreen and (ii) adjusting operation of the industrial process control and automation system.

In a second embodiment, a system includes at least one display device and a touchscreen collectively configured to present process-related information associated with an industrial process control and automation system to an operator. The touchscreen is also configured to receive user input and, based on the user input, to (i) control the process-related information presented on the at least one display device and the touchscreen and (ii) adjust operation of the industrial process control and automation system.

In a third embodiment, an apparatus includes a touch-sensitive display configured to receive input from an operator. The apparatus also includes at least one processing device configured, based on the operator input, to control process-related information presented on at least one display device of an operator console and the touch-sensitive display. The process-related information is associated with an industrial process control and automation system. The at least one processing device is also configured, based on the operator input, to adjust operation of the industrial process control and automation system.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIGS. 2 through 4 illustrate example operator consoles and related details according to this disclosure;

FIGS. 5 through 8 illustrate example operations involving touchscreens at operator consoles according to this disclosure; and

FIG. 9 illustrates an example method for combining visualization and interaction in an industrial operator console according to this disclosure.

### DETAILED DESCRIPTION

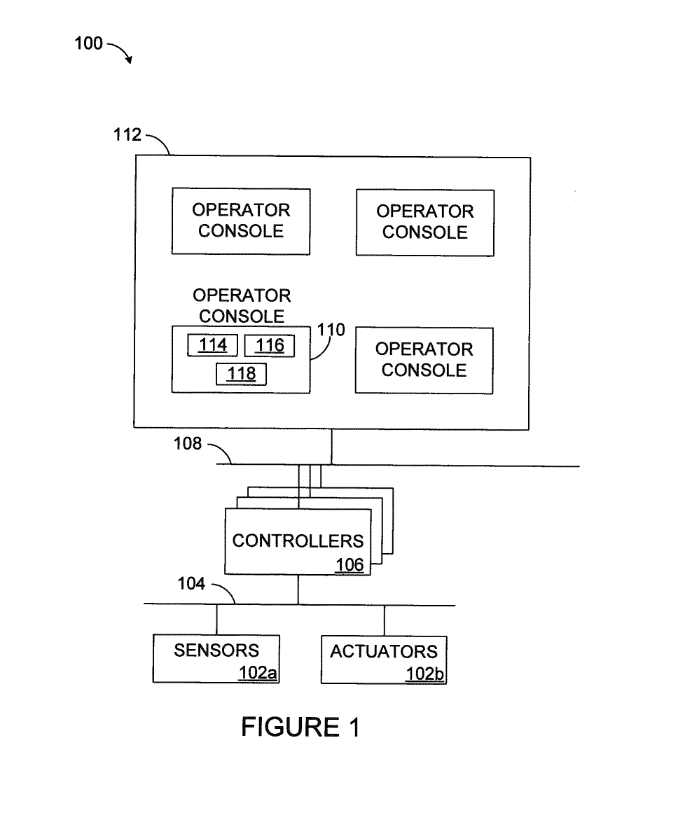

FIGS. 1 through 8, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example industrial process control and automation system 100 according to this disclosure. As shown in FIG. 1, the system 100 includes various components that facilitate production or processing of at least one product or other material. For instance, the system 100 can be used to facilitate control over components in one or multiple industrial plants. Each plant represents one or more processing facilities (or one or more portions thereof), such as one or more manufacturing facilities for producing at least one product or other material. In general, each plant may implement one or more industrial processes and can individually or collectively be referred to as a process system. A process system generally represents any system or portion thereof configured to process one or more products or other materials in some manner.

In FIG. 1, the system 100 includes one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent at least one Ethernet network, electrical signal network (such as a HART or FOUNDATION FIELDBUS network), pneumatic control signal network, or any other or additional type(s) of network(s).

Various controllers 106 are coupled directly or indirectly to the network 104. The controllers 106 can be used in the system 100 to perform various functions. For example, a first set of controllers 106 may use measurements from one or more sensors 102a to control the operation of one or more actuators 102b. A second set of controllers 106 could be used to optimize the control logic or other operations performed by the first set of controllers. A third set of controllers 106 could be used to perform additional functions.

Controllers 106 are often arranged hierarchically in a system. For example, different controllers 106 could be used to control individual actuators, collections of actuators forming machines, collections of machines forming units, collections of units forming plants, and collections of plants forming an enterprise. A particular example of a hierarchical arrangement of controllers 106 is defined as the “Purdue” model of process control. The controllers 106 in different hierarchical levels can communicate via one or more networks 108 and associated switches, firewalls, and other components.

Each controller 106 includes any suitable structure for controlling one or more aspects of an industrial process. At least some of the controllers 106 could, for example, represent multivariable controllers, such as Robust Multivariable Predictive Control Technology (RMPCT) controllers or other type of controllers implementing model predictive control (MPC) or other advanced predictive control (APC).

Operator access to and interaction with the controllers 106 and other components of the system 100 can occur via various operator consoles 110. As described above, each operator console 110 could be used to provide information to an operator and receive information from an operator. For example, each operator console 110 could provide information identifying a current state of an industrial process to the operator, including warnings, alarms, or other states associated with the industrial process. Each operator console 110 could also receive information affecting how the industrial process is controlled, such as by receiving setpoints for process variables controlled by the controllers 106 or by receiving other information that alters or affects how the controllers 106 control the industrial process.

Multiple operator consoles 110 can be grouped together and used in one or more control rooms 112. Each control room 112 could include any number of operator consoles 110 in any suitable arrangement. In some embodiments, multiple control rooms 112 can be used to control an industrial plant, such as when each control room 112 contains operator consoles 110 used to manage a discrete part of the industrial plant.

Each operator console 110 includes any suitable structure for displaying information to and interacting with an operator. For example, each operator console 110 could include one or more processing devices 114, such as one or more processors, microprocessors, microcontrollers, field programmable gate arrays, application specific integrated circuits, discrete logic devices, or other processing or control devices. Each operator console 110 could also include one or more memories 116 storing instructions and data used, generated, or collected by the processing device(s) 114. Each operator console 110 could further include one or more network interfaces 118 that facilitate communication over at least one wired or wireless network, such as one or more Ethernet interfaces or wireless transceivers.

Operators are typically responsible for managing industrial processes and often need to act quickly and efficiently to maintain safe and profitable operations. To do this, operators are often constantly engaged in a process of orienting themselves to the current state of an industrial process, evaluating whether the current state requires human intervention, and (if so) performing the interventions and assessing the outcomes of the interventions.

A conventional operator console supporting these functions typically includes one or more display screens and one or more keyboards and pointing devices, such as mice or trackballs. Unfortunately, this arrangement often requires operators to divide their attention between the visualization of process information on the display screens (which are often oriented substantially vertically) and user input devices (which are often located on substantially horizontal work surfaces). For example, changing a process parameter often involves an operator selecting the parameter on a display screen using a mouse, finding and pressing the relevant keys on a keyboard, and viewing the results on the display screen. Because of this, operators often need to look back and forth between their display screens and their user input devices, and the operators often need to move their hands back and forth between different input devices in order to change process parameters. Divided attention and the need to switch between input devices make the overall process less efficient than it could be.

In accordance with this disclosure, an operator console 110 includes or operates in conjunction with a touchscreen. The touchscreen combines the visualization of process information with a mechanism for interacting with that information. The touchscreen also supports a mechanism for moving content between the touchscreen and at least one other display screen of the operator console 110. The touchscreen further allows for the management of the process information on the at least one other display screen and generally supports a wide variety of interactions.

Although FIG. 1 illustrates one example of an industrial process control and automation system 100, various changes may be made to FIG. 1. For example, industrial control and automation systems come in a wide variety of configurations. The system 100 shown in FIG. 1 is meant to illustrate one example operational environment in which touchscreens can be incorporated into or used with operator consoles. FIG. 1 does not limit this disclosure to any particular configuration or operational environment.

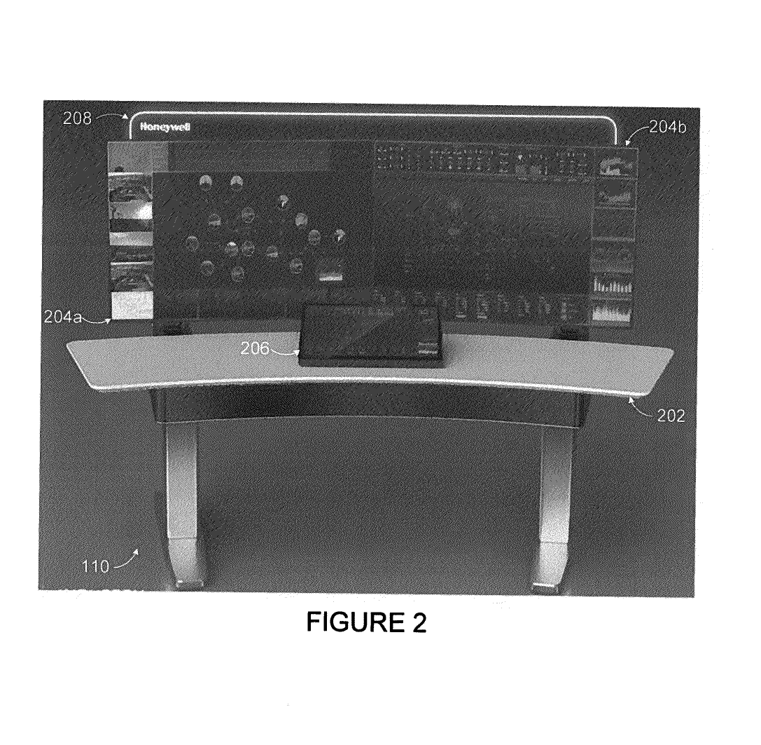

FIGS. 2 through 4 illustrate example operator consoles 110 and related details according to this disclosure. As shown in FIG. 2, one example of the operator console 110 is positioned on a desk 202. The desk 202 supports components of the operator console 110 and could be used to hold or retain electronics under the operator console 110.

The operator console 110 includes one or more display screens 204a-204b placed on, mounted to, or otherwise associated with the desk 202. The display screens 204a-204b can be used to present various information to an operator. For instance, the display screens 204a-204b could be used to present a human-machine interface (HMI) display that includes diagrams of an industrial process being controlled and information associated with the current state of the industrial process being controlled. The HMI display could also be used to receive information from an operator. Each display screen 204a-204b includes any suitable display device, such as a liquid crystal display (LCD) device or a light emitting diode (LED) display device. In this example, there are two display screens 204a-204b adjacent to and angled with respect to one another. However, an operator console 110 could include any number of display screens in any suitable arrangement.

The operator console 110 in this example also includes a touchscreen 206. The touchscreen 206 here is placed on the desk 202 and can be positioned at an angle, such as about 15° to about 35°. The angle of the touchscreen 206 could be adjustable. The touchscreen 206 can be used to interact with the HMI displays presented on the display screens 204a-204b and to control the content on the display screens 204a-204b. The touchscreen 206 could also display additional HMI displays and other information not presented on the display screens 204a-204b. The touchscreen 206 includes any suitable display device with touch sensitivity, such as an LCD or LED touchscreen.

The operator console 110 further includes an ambient display 208, which in this example is positioned at the top of the display screens 204a-204b. The ambient display 208 can output light having different characteristic(s) to identify the current status of an industrial process (or portion thereof) being monitored or controlled using the operator console 110. For example, the ambient display 208 could output green light or no light when the current status of an industrial process or portion thereof is normal. The ambient display 208 could output yellow light when the current status of an industrial process or portion thereof indicates that a warning has been issued. The ambient display 208 could output red light when the current status of an industrial process or portion thereof indicates that an alarm has been issued. Note that other or additional characteristics of the ambient light can also be controlled, such as the intensity of light or the speed of transitions in the light. The ambient display 208 here represents an edge-lit glass segment or other clear segment, where one or more edges of the segment can be illuminated using an LED strip or other light source. Note, however, that the use of the ambient display 208 is optional.

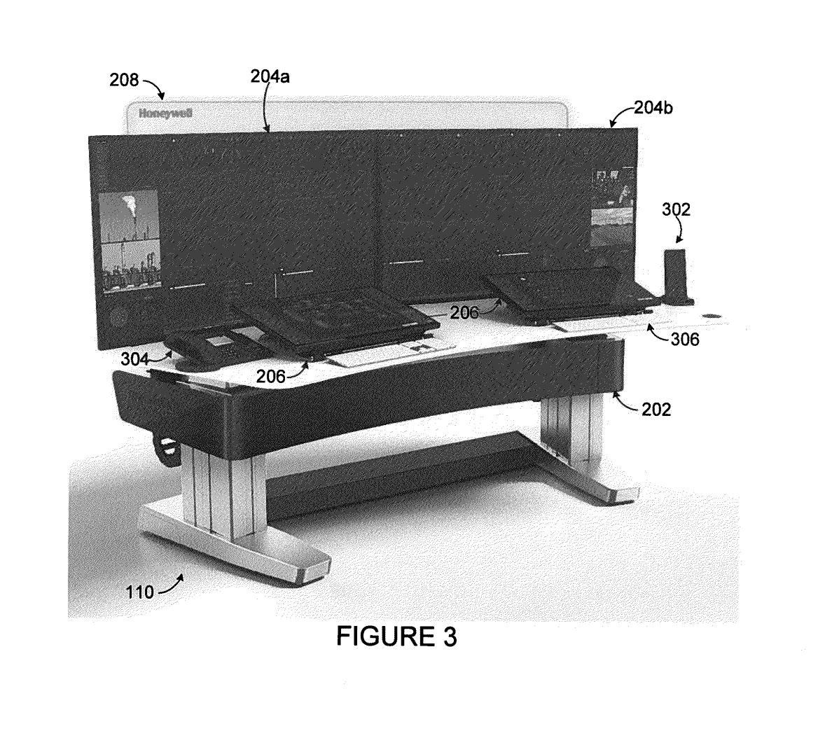

As shown in FIG. 3, another example of the operator console 110 is positioned on the desk 202 and includes the display screens 204a-204b and the ambient display 208. The operator console 110 in this example also includes multiple instances of the touchscreen 206, where each touchscreen 206 is associated with a different display screen 204a-204b.

The operator console 110 in this example also includes a mobile device 302. The mobile device 302 can be used to support interactions between an operator and HMIs presented on the display screens 204a-204b. For example, the mobile device 302 could include a touchscreen that can be used to control the content on the display screens 204a-204b and to interact with the HMIs presented on the display screens 204a-204b. Moreover, the mobile device 302 could receive and display information to an operator, such as current process variable values or process states, when the operator moves away from the operator console 110. The mobile device 302 includes any suitable device that is mobile and that supports interaction with an operator console, such as a tablet computer or smartphone. Note, however, that the use of the mobile device 302 is optional.

The operator console 110 in this example further includes a desktop telephone 304 and one or more keyboards 306. The desktop telephone 304 could represent any suitable analog or digital telephone. Each keyboard 306 includes any suitable structure for providing physical keys that can be depressed by an operator. Note, however, that the use of the desktop telephone 304 and the keyboard 306 is optional.

As an alternative to conventional operator console interfaces, the operator console 110 combines both visualizing and interacting with industrial processes within one user interface device (a touchscreen 206). The touchscreen 206 features high-resolution graphics for visualization and touchscreen technology for interaction. The touchscreen 206 presents process visualizations that allow direct touch gesture interactions. Example operations that could be triggered using the touchscreen 206 include navigating information in a display (such as scrolling a trend) and manipulating process parameters (such as changing a setpoint). An operator can manipulate visualizations directly with touch gestures on the touchscreen 206 rather than using separate input devices like a keyboard and a mouse/trackball.

Any suitable touch gestures could be supported by the touchscreen 206, such as discrete tapping gestures to select pre-defined values presented on the touchscreen 206 and continuous sliding, dragging, or pinching gestures to select values from a continuous range. As another example, the touchscreen 206 can support a mechanism to easily move content between the touchscreen 206 and one or more display screens 204a-204b (or vice versa) using simple touch gestures on the touchscreen 206. These “content management” operations could include calling up an HMI display on the touchscreen 206, pushing an HMI display from the touchscreen 206 up to a display screen 204a-204b, and pulling an HMI display from a display screen 204a-204b down onto the touchscreen 206. These content management operations can function across display or device boundaries when a console 110 includes multiple display devices or multiple computing devices.

The ergonomically-sound arrangement of the touchscreens 206 and the direct manipulation interfaces allow operators to work more effectively and efficiently over long periods of time. All touch-based data entry operations can be optimized for efficiency and safety to exclude inaccurate or accidental inputs. Moreover, the operator consoles 110 allow operators to efficiently bring HMI displays onto the touchscreens 206 for direct interaction without having to divide their attention or move their hands between different input devices.

In particular embodiments, a touchscreen 206 can be driven by a computing device (either within the touchscreen 206 or external to the touchscreen 206), and the display(s) 204a-204b could be driven by a separate computing device. This could provide a form of fault tolerance in an operator console 110. That is, if the computer driving the display(s) 204a-204b fails, the touchscreen 206 could still be used to maintain control over an industrial process (or vice versa). Note that a keyboard 306 could be provided in a hidden or other storage location that is accessible if and when the touchscreen 206 of an operator console 110 fails.

Also, in particular embodiments, an operator console 110 could be implemented using a modified form of the EXPERION HMI platform from HONEYWELL INTERNATIONAL INC. The modifications can include modifications enabling safe and reliable touch-based interaction with HMI displays and modifications enabling the movement of content between screens of a console.

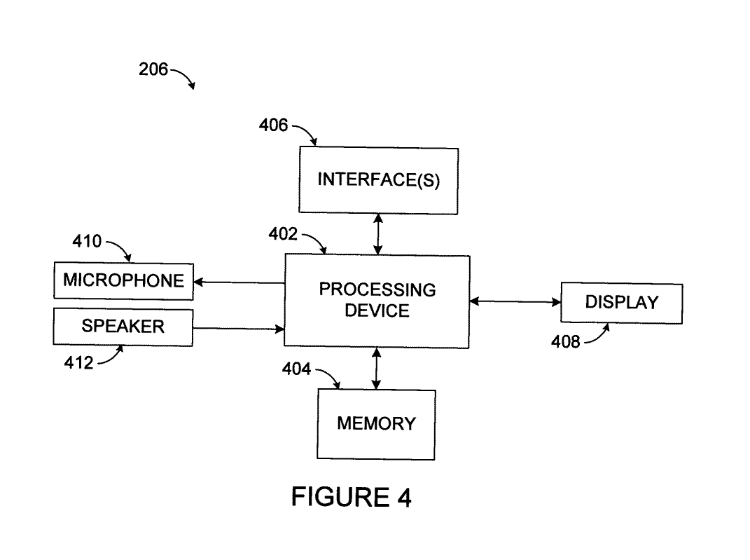

As shown in FIG. 4, a touchscreen 206 includes at least one processing device 402, which controls the overall operation of the touchscreen 206. For example, the processing device 402 may control interactions with an operator console 110, such as by identifying gestures related to displaying or changing content on one or more display screens 204a-204b of the operator console 110. The processing device 402 may also control interactions with an external control system, such as by identifying gestures related to retrieving process variable values or other content from the control system and changing process variable values or other content that is delivered to the control system. As noted above, the operator console 110 could include a separate computing device, and the processing device 402 of the touchscreen 206 could interact with the separate computing device to control or modify the contents on the one or more display screens 204a-204b. The processing device 402 includes any suitable structure for controlling the operation of a touchscreen. As particular examples, the processing device 402 could include one or more processors, microprocessors, microcontrollers, field programmable gate arrays, application specific integrated circuits, discrete logic devices, or other processing or control devices.

At least one memory 404 stores any of a wide variety of information used, collected, or generated by the touchscreen 206. For example, the memory 404 could store instructions executed by the processing device(s) 402, as well as data transmitted to or received from the operator console 110 and data received from an operator. The memory 404 includes any suitable volatile and/or non-volatile storage and retrieval device or devices.

At least one interface 406 supports interaction with external devices or systems, such as a computing device within the operator console 110 or an external control system. Each interface 406 includes any suitable structure supporting communications over physical or wireless paths. For example, a touchscreen 206 could include a wired USB, FIREWIRE, THUNDERBOLT, Ethernet, or other physical connection(s) to an operator console or other devices. A touchscreen 206 could also or alternatively include a wireless WIFI, BLUETOOTH, or other wireless connection to an operator console or other devices. Any number of interfaces 406 could be supported.

The touchscreen 206 further includes a display 408. The display 408 represents a touch-sensitive display for presenting text, images, or other data to an operator and receiving inputs from an operator. The display 408 includes any suitable touch-sensitive display, such as an LCD or LED touchscreen.

Depending on the implementation, the touchscreen 206 could include various other components, such as a microphone 410 and a speaker 412. The microphone 410 can be used to capture audio information, such as voice communications from an operator. The speaker 412 can be used to generate audio information, such as audible alarms or voice information received from another operator engaging in a voice communication session with the touchscreen 206.

A touchscreen 206 could support various other functions as needed or desired. For instance, the touchscreen 206 could be portable, and the processing device(s) 402 of the touchscreen 206 could interact with the computing device coupled to the display screen(s) 204a-204b of an operator console 110, such as when the touchscreen 206 is moved to within a specified distance of or physically docks with the operator console 110. The touchscreen 206 could do this each time the touchscreen 206 is moved to a different operator console 110, and information stored in the touchscreen 206 or elsewhere could be used to update a specific operator console 110 each time the touchscreen 206 interfaces with that specific operator console 110.

Although FIGS. 2 through 4 illustrate examples of operator consoles 110 and related details, various changes may be made to FIGS. 2 through 4. For example, an operator console 110 could have any combination of the features shown in FIGS. 2 and 3, such as when a feature shown in one figure is used in another figure. Also, various components in FIGS. 2 through 4 could be combined, subdivided, or omitted and additional components could be added according to particular needs. As a particular example, the processing device 402 could be implemented using a central processing unit (CPU) and a graphics processing unit (GPU). In addition, an operator console 110 could include any number of display devices and touchscreens, with any suitable association between the display devices and touchscreens.

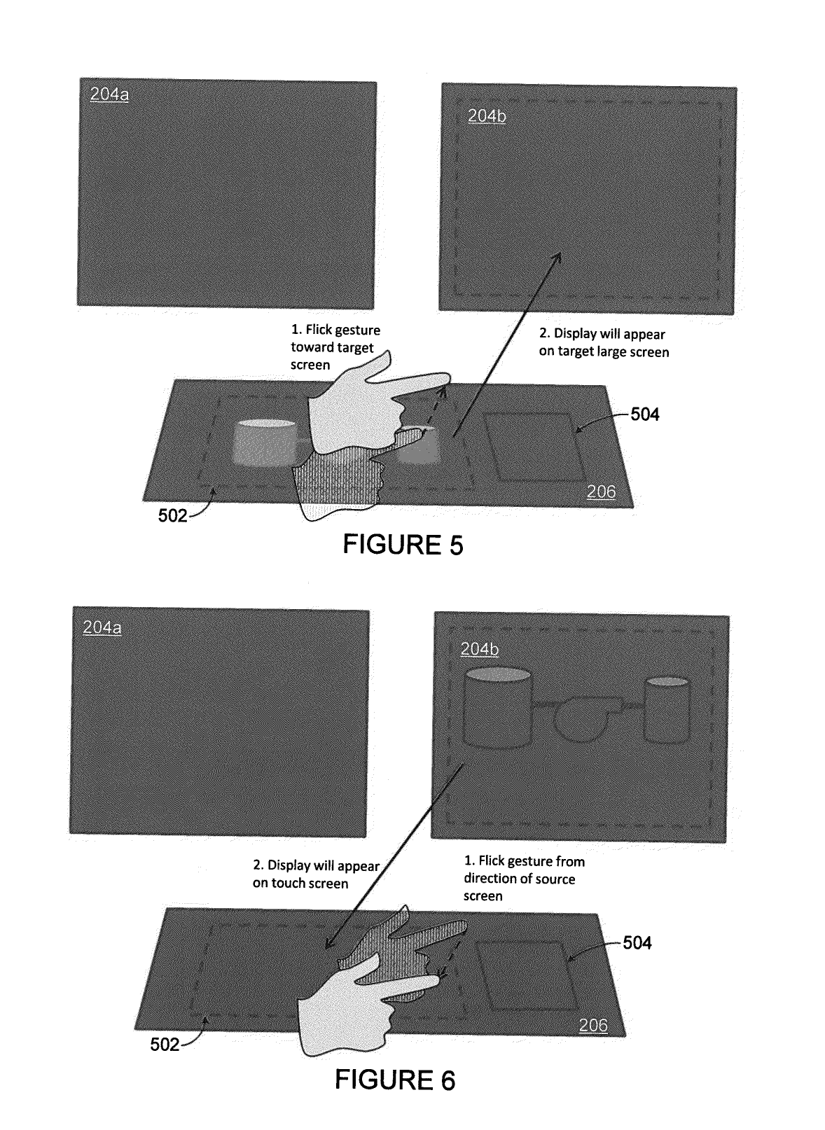

FIGS. 5 through 8 illustrate example operations involving touchscreens 206 at operator consoles 110 according to this disclosure. As shown in FIG. 5, one example use of the touchscreen 206 at an operator console 110 is to “push” an HMI display from the touchscreen 206 to a larger display screen (display screen 204b in this example). Here, an operator can call up the HMI display on the touchscreen 206 and perform any desired operations with the HMI display. The operator can make a flicking gesture towards the larger display screen 204b on which the operator wishes to view the HMI display, which causes the HMI display to then be presented on the display screen 204b.

As shown in FIG. 6, another example use of the touchscreen 206 at an operator console 110 is to “pull” an HMI display from a larger display screen (display screen 204b in this example) to the touchscreen 206. Here, an operator can make a flicking gesture from the larger display screen 204b on which the operator is currently viewing the HMI display. This causes the HMI display to then be presented on the touchscreen 206, where the operator can perform any desired operations with the HMI display.

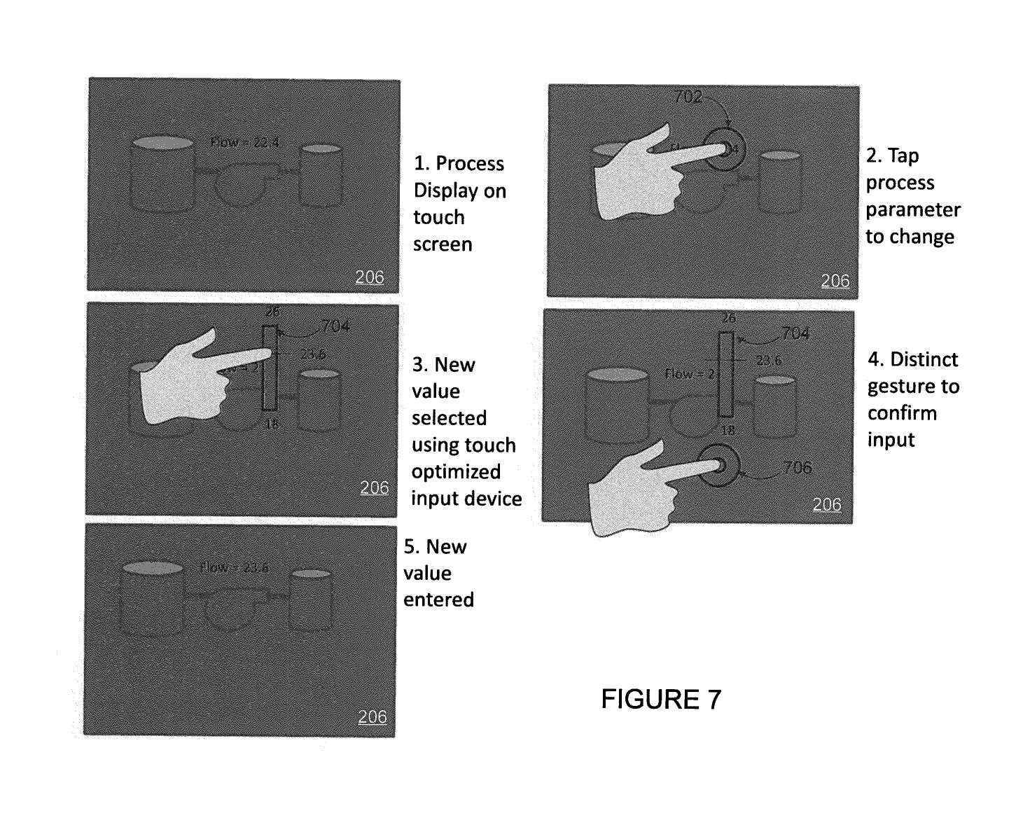

As shown in FIG. 7, when an HMI display is shown on the touchscreen 206, one example interaction that can occur involves the operator touching a process parameter in order to change the parameter's value. For example, in response to detecting a touch 702 of the process parameter, the touchscreen 206 could display a slide bar 704 that allows the user to slide the parameter's value up or down. Once the parameter has the desired value, the operator can make a gesture that confirms acceptance of the value, such as by touching a confirmation button 706 or an area of the touchscreen 206 away from the slide bar 704. The touchscreen 206 could then transmit the new value of the process variable to an external control system.

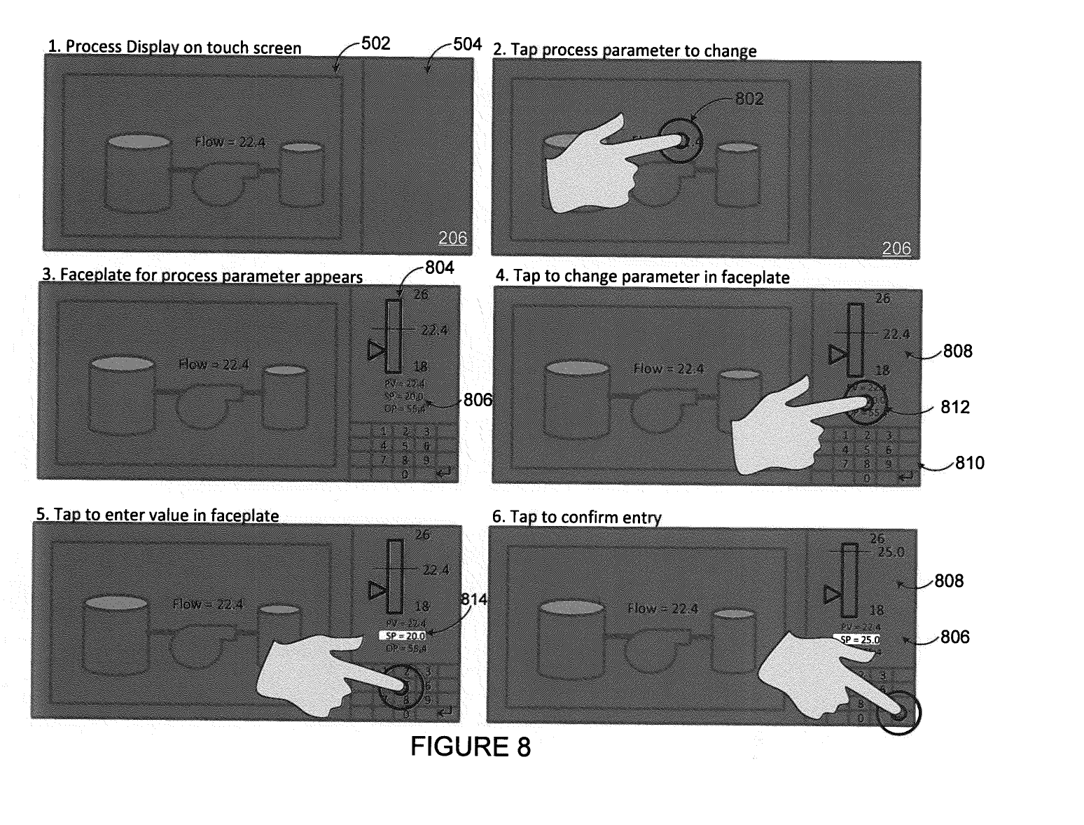

FIG. 8 illustrates another example technique allowing an operator to change a parameter's value. In this example, the touchscreen 206 is showing an HMI display, which identifies a current flow rate process value (PV). In response to detecting a touch 802 of the process parameter, the touchscreen 206 could display a faceplate 804, which is used by the operator to adjust the process parameter. The faceplate 804 includes text 806 identifying one or more values associated with the process parameter. In this example, the text 806 identifies the current PV, the current process parameter setpoint (SP), and the current output value (OP) associated with the process parameter (such as the speed of a pump that provides the current flow rate). The faceplate 804 also includes a graphic 808 identifying the current acceptable range of the process parameter PV, the current PV denoted with a line and a text value, and the current setpoint denoted with a triangle. A soft keypad 810 is displayed on the touchscreen 206, and the operator can use the keypad 810 to provide a new value for any of the values in the text 806. Here, the operator makes a touch 812 of the SP value, which causes the touchscreen 206 to display the SP value with highlighting 814. The operator enters a new value using the keypad 810, and the operator console 110 updates both the text 806 and the graphic 808 with the new value. The same process could be used to change any of the values in the HMI display.

In FIGS. 5, 6, and 8, the touchscreen 206 is divided into multiple areas 502-504. The area 502 could denote the portion of the touchscreen 206 in which an HMI display showing process controls or other industrial process-related information (such as the HMI display of FIG. 7) can be presented. The gesture shown in FIG. 5 to “push” an HMI display could originate within the area 502 and terminate outside the area 502. The gesture shown in FIG. 6 to “pull” an HMI display could originate outside the area 502 and terminate inside the area 502, where the pulled HMI display could be selected in any suitable manner. The selection of the process parameter in FIG. 8 could occur within the area 502.

The area 504 could denote a portion of the touchscreen 206 that can be used by an operator to navigate within or between display screens 204a-204b. For example, as shown above, a soft keypad or other data-entry mechanism(s) could be displayed in the area 504. Also, an operator could move his or her finger within the area 504 of the touchscreen 206 to move a cursor or other displayed pointer within the display screen(s). The operator could further tap within the area 504 of the touchscreen 206 to select an item in a display screen, such as the item on which the displayed pointer currently sits. In addition, the operator could flick his or her finger within the area 504 of the touchscreen 206 to jump between the display screens or perform other functions. Multi-touch gestures could also be supported, such as a multi-finger tap or scroll function, a pinch function, a zoom function, or a rotate function.

Note that the division of the touchscreen 206 using the areas 502-504 is for illustration only. A touchscreen 206 that operates in any other suitable manner could also be used here. For example, the surface of the touchscreen 206 could be mapped to the surface(s) of the display screen(s) 204a-204b so that the touchscreen 206 could be used to navigate to specific locations on the display screen(s) 204a-204b. Single-touch or multi-touch gestures could then be used to perform various functions, such as those described above.

Also note that the information presented on the display screens 204a-204b/touchscreen 206 could be obtained from any suitable source(s), and the information obtained by the touchscreen 206 could be provided to any suitable destination(s). For example, the information presented on the display screens 204a-204b or the touchscreen 206 could be obtained from one or more controllers 106, one or more historians storing data associated with a control and automation system, or other component(s) of the system. Similarly, the information obtained by the touchscreen 206 could be provided to one or more controllers 106, one or more historians storing data associated with a control and automation system, or other component(s) of the system.

Finally, the specific touch interactions shown in FIGS. 5 through 8 are meant to illustrate example ways in which touch functionality could be used at an operator console 110 of a control and automation system. A wide variety of touch-based functions could be supported using a touchscreen 206 of an operator console 110. Example usages include situations where (i) the display screens 204a-204b are meant to be the primary focus of an operator's attention and the touchscreen 206 is meant to facilitate user interactions or (ii) the touchscreen 206 is meant to be the primary focus of an operator's attention and to facilitate user interactions and the display screens 204a-204b are meant to present information supporting operator actions.

Although FIGS. 5 through 8 illustrate examples of operations involving touchscreens 206 at operator consoles 110, various changes may be made to FIGS. 5 through 8. For example, as noted above, a touchscreen 206 is not limited to use with two display devices and could be used with a single display device or more than two display devices. Also, FIGS. 5 through 8 are meant to illustrate example ways in which touch gestures could be used to facilitate user interactions with an operator console 110. Any other suitable touch gestures could be used to facilitate any other user interactions with an operator console 110. In addition, while a soft keypad is shown in FIG. 8, other input mechanisms could be used, such as an entire soft keyboard or a custom set of soft buttons.

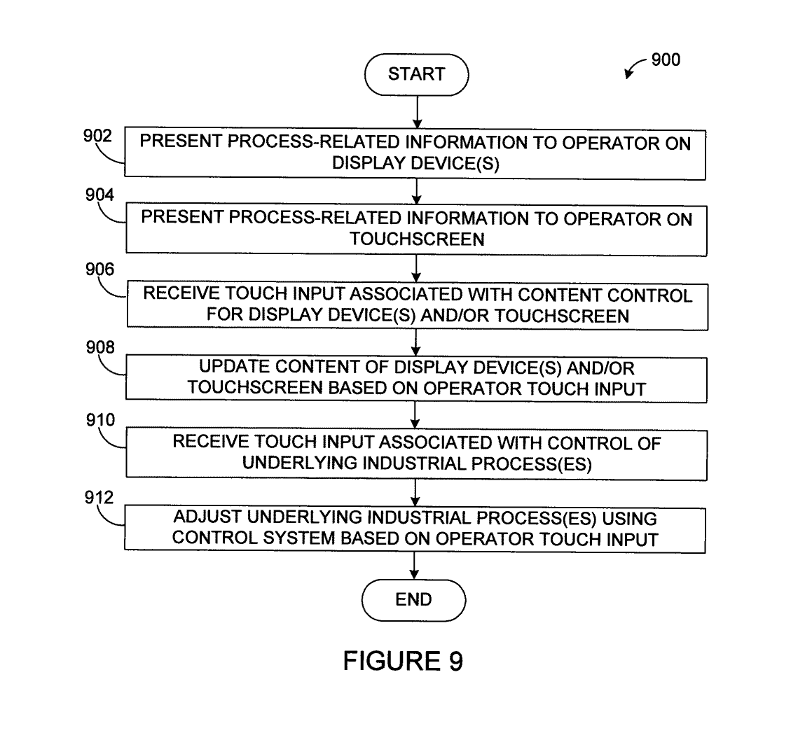

FIG. 9 illustrates an example method 900 for combining visualization and interaction in an industrial operator console according to this disclosure. For ease of explanation, the method 900 is described with respect to the operator consoles 110 shown in FIGS. 2 and 3 being used in the system 100 of FIG. 1. However, the method 900 could be used by any suitable operator console and in any suitable system.

As shown in FIG. 9, process-related information is presented to an operator on one or more display devices at step 902, and process-related information is presented to the operator on a touchscreen at step 904. The process-related information presented here could represent any suitable data, such as one or more diagrams of at least one industrial process, controls for monitoring or altering the at least one industrial process, or other information. The process-related information presented here could also vary based on a number of factors, such as the current task being performed by the operator. The process-related information presented on the display screens 204a-204b may or may not be related to the process-related information presented on the touchscreen 206. As an example, the process-related information presented on the display screens 204a-204b could include a wider overall view of a process being controlled, and the process-related information presented on the touchscreen 206 could relate to a smaller specific portion of the process being controlled. As a particular example, the process-related information presented on the display screens 204a-204b could include trend diagrams for multiple variables associated with an industrial process, and the process-related information presented on the touchscreen 206 could include controls used to modify the displayed variables or to modify other variables that affect the displayed variables.

Touch inputs associated with the control of content presented on the one or more display devices or the touchscreen are received at step 906, and the content on the one or more display devices or the touchscreen is updated at step 908. This could include, for example, the operator using the touchscreen 206 to pull content from one or more of the display screens 204a-204b onto the touchscreen 206 or the operator using the touchscreen 206 to push content from the touchscreen 206 onto one or more of the display screens 204a-204b. This could also include the operator using the touchscreen 206 to call up specific information onto one or more of the display screens 204a-204b or the touchscreen 206.

Touch inputs associated with the control of at least one underlying industrial process is received at step 910, and the at least one underlying industrial process is adjusted using a control system at step 912. This could include, for example, the operator using the touchscreen 206 to provide new setpoints or other values for process variables, which can be provided to process controllers, servers, or other devices controlling the underlying industrial processes. This could also include the operator using the touchscreen 206 to change the mode of operation of control devices, such as by switching process controllers controlling the underlying industrial processes between manual and automated modes. This could further include the operator using the touchscreen 206 to acknowledge warnings or alarms and take corrective action in response to the warnings or alarms. In general, a wide variety of controls can be used with one or more display devices and a touchscreen in order to monitor or adjust one or more underlying industrial processes.

Although FIG. 9 illustrates one example of a method 900 for combining visualization and interaction in an industrial operator console, various changes may be made to FIG. 9. For example, while shown as a series of steps, various steps in each figure could overlap, occur in parallel, occur in a different order, or occur any number of times.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
presenting process-related information associated with an industrial process control and automation system to an operator using at least one display device and a touchscreen of an operator console;
receiving user input via the touchscreen; and
based on the user input, (i) controlling the process-related information presented on the at least one display device and the touchscreen and (ii) adjusting operation of the industrial process control and automation system.

2. The method of claim 1, wherein controlling the process-related information comprises:
based on the user input, moving content from the at least one display device to the touchscreen.

3. The method of claim 1, wherein controlling the process-related information comprises:
based on the user input, moving content from the touchscreen to the at least one display device.

4. The method of claim 1, wherein adjusting the operation of the industrial process control and automation system comprises:
receiving a new value of a process variable based on a first user input; and
receiving an acceptance of the new value of the process variable based on a second user input.

5. The method of claim 1, wherein controlling the process-related information comprises:
based on the user input, presenting multiple human-machine interface (HMI) displays on the at least one display device and the touchscreen.

6. The method of claim 1, wherein:
the at least one display device presents a wider overall view of an industrial process being controlled; and
the touchscreen presents a smaller specific portion of the industrial process being controlled.

7. The method of claim 1, wherein:
the at least one display device presents multiple trend diagrams for multiple process variables associated with an industrial process; and
the touchscreen presents controls for modifying the process variables or for modifying other variables that affect the process variables.

8. A system comprising:
at least one display device and a touchscreen collectively configured to present process-related information associated with an industrial process control and automation system to an operator;
the touchscreen also configured to receive user input and, based on the user input, to (i) control the process-related information presented on the at least one display device and the touchscreen and (ii) adjust operation of the industrial process control and automation system.

9. The system of claim 8, wherein the touchscreen is configured to control the process-related information by, based on the user input, moving content from the at least one display device to the touchscreen.

10. The system of claim 8, wherein the touchscreen is configured to control the process-related information by, based on the user input, moving content from the touchscreen to the at least one display device.

11. The system of claim 8, wherein the touchscreen is configured to adjust the operation of the industrial process control and automation system by:
receiving a new value of a process variable based on a first user input; and
receiving an acceptance of the new value of the process variable based on a second user input.

12. The system of claim 8, wherein the touchscreen is configured to control the process-related information by, based on the user input, controlling presentation of multiple human-machine interface (HMI) displays on the at least one display device and the touchscreen.

13. The system of claim 8, wherein:
the at least one display device is configured to present a wider overall view of an industrial process being controlled; and
the touchscreen is configured to present a smaller specific portion of the industrial process being controlled.

14. The system of claim 8, wherein:
the at least one display device is configured to present multiple trend diagrams for multiple process variables associated with an industrial process; and
the touchscreen is configured to present controls for modifying the process variables or for modifying other variables that affect the process variables.

15. An apparatus comprising:
a touch-sensitive display configured to receive input from an operator; and
at least one processing device configured, based on the operator input, to:
control process-related information presented on at least one display device of an operator console and the touch-sensitive display, the process-related information associated with an industrial process control and automation system; and
adjust operation of the industrial process control and automation system.

16. The apparatus of claim 15, wherein the at least one processing device is configured, based on the user input, to at least one of:
move content from the at least one display device to the touch-sensitive display; and
move content from the touch-sensitive display to the at least one display device.

17. The apparatus of claim 15, wherein the at least one processing device is configured to:
receive a new value of a process variable based on a first user input; and
receive an acceptance of the new value of the process variable based on a second user input.

18. The apparatus of claim 15, wherein the at least one processing device is configured, based on the user input, to present multiple human-machine interface (HMI) displays on the at least one display device and the touch-sensitive display.

19. The apparatus of claim 15, wherein the at least one processing device is configured to:
present on the at least one display device a wider overall view of an industrial process being controlled; and
present on the touch-sensitive display a smaller specific portion of the industrial process being controlled.

20. The apparatus of claim 15, wherein the at least one processing device is configured to:
present on the at least one display device multiple trend diagrams for multiple process variables associated with an industrial process; and
present on the touch-sensitive display controls for modifying the process variables or for modifying other variables that affect the process variables.
